(19) United States
(12) Patent Application Publication
(10) Pub. No.: US 2026/0338340 A1
(43) Pub. Date: Oct. 29, 2026

(54) LAMP FOR VEHICLE

(71) Applicant: HYUNDAI MOBIS CO., LTD., Seoul (KR)

(72) Inventor: Min Ji JIN, Yongin-si (KR)

(73) Assignee: HYUNDAI MOBIS CO., LTD., Seoul (KR)

(21) Appl. No.: 19/454,556

(22) Filed: Jan. 21, 2026

(30) Foreign Application Priority Data
Apr. 25, 2025 (KR) 10-2025-0054610

(51) Int. Cl. F21S 41/265; F21S 41/24; F21S 41/26; F21S 41/27; F21W 102/13; F21W 102/20

(52) U.S. Cl. CPC F21S 41/265; F21S 41/24; F21S 41/26; F21S 41/27; F21W 2102/13; F21W 2102/20

(57) ABSTRACT

A vehicle lamp includes a first light source part and a second light source part spaced apart by a predetermined distance. A first incident lens part and a second incident lens part are integrated and disposed forward of the light source parts to propagate light forward. Integrated first and second emergent lens parts are disposed forward of the incident lens parts to receive exiting light. The first light source, incident lens, and emergent lens parts are configured to form a central light distribution. The second light source, incident lens, and emergent lens parts are configured to form a peripheral light distribution surrounding the central light distribution. These distributions overlap to collectively form a low-beam light distribution pattern, providing a simplified component structure that minimizes assembly tolerances and improves luminous efficiency.

### CROSS-REFERENCE TO RELATED APPLICATION

This application claims priority to and the benefit under 35 USC § 119(a) of Korean Patent Application No. 10-2025-0054610 filed in the Korean Intellectual Property Office on Apr. 25, 2025, the entire contents of which are incorporated herein by reference under 35 USC § 119(a).

### TECHNICAL FIELD

The present disclosure relates to a lamp for a vehicle. More specifically, the present disclosure relates to a lamp for a vehicle in which a first incident lens part and a second incident lens part are integrated to form a plurality of light distribution patterns.

### BACKGROUND ART

In general, a vehicle includes various types of lamps having a lighting function and a signal function. The lighting function allows a driver to easily recognize objects positioned around the vehicle during nighttime driving. The signal function informs drivers in other vehicles and pedestrians on the road of a traveling state of the host vehicle.

For example, the lamps include headlamps (or headlights) and fog lamps mainly used for the lighting function, and turn signal lamps, tail lamps, brake lamps, and side markers used for the signal function. The regulations define the installation criteria and specifications of these lamps for a vehicle to enable the lamps to sufficiently exhibit the functions.

Among the lamps for a vehicle, the headlamp provides a low-beam pattern or a high-beam pattern to ensure a front visual field of the driver while the vehicle travels at night. The headlamp plays a significantly important role in safe driving.

Meanwhile, recently, exterior designs of the headlamps and light distribution patterns are also considered important in addition to the performance of the headlamps.

However, in the related, a light distribution pattern needs to be formed by applying an aspherical lens having a single focal point, which makes it difficult to various designs of headlamps and light distribution patterns. As a result, there is a limitation in implementing design characteristics, and it is difficult to meet rapidly changing consumer demands.

In addition, in the related art, different optical systems need to be used to form long-distance light distribution patterns and short-distance light distribution patterns, which causes a problem in that structure and manufacturing processes are complicated, and manufacturing costs are increased.

Therefore, recently, various studies have been conducted to achieve both structural simplification and improved design flexibility and luminous efficiency by integrating optical structures and reducing the number of components, but the study results are still insufficient. Accordingly, there is a need to develop a technology to achieve both the structural simplification and the improved design flexibility and luminous efficiency by integrating the optical structures and reducing the number of components.

### SUMMARY

The present disclosure has been made in an effort to provide a lamp for a vehicle that improves luminous efficiency by simplifying an assembling process by means of component simplification and minimizing assembling tolerances.

In one general aspect, a lamp for a vehicle includes a first light source part comprising one or more first light sources configured to emit light; a second light source part comprising one or more second light sources configured to emit light, the second light source part being spaced apart from the first light source part by at least a predetermined distance; a first incident lens part disposed forward of the first light source part and configured to allow the light emitted from the first light source part to propagate forward; a second incident lens part disposed forward of the second light source part and configured to allow the light emitted from the second light source part to propagate forward; a first emergent lens part disposed forward of the first incident lens part to receive the light exiting from the first incident lens part; and a second emergent lens part disposed forward of the second incident lens part to receive the light exiting from the second incident lens part, wherein the second incident lens part is integrated with the first incident lens part at one side of the first incident lens part in a horizontal direction, wherein the second emergent lens part is integrated with the first emergent lens part at one side of the first emergent lens part in the horizontal direction, wherein the first light source part, the first incident lens part, and the first emergent lens part are configured to form a central light distribution, and the second light source part, the second incident lens part, and the second emergent lens part are configured to form a peripheral light distribution surrounding the central light distribution to collectively form a low-beam light distribution pattern.

The first incident lens part may include one or more first light entering portions facing the first light source and configured to totally reflect the light emitted from the first light source; and a first body portion provided forward of and integrated with the first light entering portion, the first body portion including a light exit surface configured to allow the light guided through the first body portion to propagate forward, wherein the first light entering portion is formed in a shape protruding rearward from the first body portion.

The first light entering portion may include a first central incident portion configured to refract a first central light beam, which is a part of the light emitted from the first light source, toward a central region of the light exit surface of the first body portion; and a first outer peripheral incident portion surrounding the first central incident portion and configured to totally reflect a first peripheral light beam, which is another part of the light emitted from the first light source, toward the central region of the light exit surface of the first body portion, and wherein a distance in a forward/rearward direction between a lower end of the first outer peripheral incident portion and the first light source part is longer than a distance in the forward/rearward direction between an upper end of the first outer peripheral incident portion and the first light source part.

The light exit surface of the first body portion may be concavely curved rearward in a cross-sectional view along the horizontal direction.

The light exit surface of the first body portion may further include a protrusion portion protruding forward from one side of the light exit surface of the first body portion.

The protrusion portion may be biased toward the second incident lens part with respect to a center of the first body portion in the horizontal direction.

A plurality of first light entering portions may be formed such that optical axes of the plurality of first light entering portions converge toward a central axis of the light exit surface of the first body portion in a forward direction.

A lower surface of the first body portion may be inclined upward in a direction toward the first light exit surface.

The second incident lens part may include one or more second light entering portions facing the second light source and configured to totally reflect the light emitted from the second light source; and a second body portion provided forward of and integrated with the second light entering portion, the second light entering portion including a light exit surface configured to allow the light guided through the second body portion to propagate forward, wherein the second light entering portion is formed in a shape protruding rearward from the second body portion.

The second light entering portion may include a second central incident portion configured to refract a second central light beam, which is a part of the light emitted from the second light source, toward a central region of the light exit surface of the second body portion; and a second outer peripheral incident portion surrounding the second central incident portion and configured to totally reflect a second peripheral light beam, which is another part of the light emitted from the second light source, toward the central region of the light exit surface of the second body portion, and wherein a distance in a forward/rearward direction between a lower end of the second outer peripheral incident portion and the second light source part is longer than a distance in the forward/rearward direction between an upper end of the second outer peripheral incident portion and the second light source part.

The light exit surface of the second body portion may be convexly curved forward in a cross-sectional view along the horizontal direction.

A lower surface of the second body portion may be inclined upward in a direction toward the second light exit surface.

13. The lamp of claim 1, wherein the first emergent lens part comprises:
a first incident surface configured to allow the light exiting from the first incident lens part to enter the first incident surface; and
a first emergent surface configured to allow the light entering the first incident surface to propagate forward,
wherein the first incident surface is convexly curved rearward in a cross-sectional view along the horizontal direction, and
wherein the first emergent surface is convexly curved forward in a cross-sectional view along the horizontal direction.

14. The lamp of claim 1, wherein the second emergent lens part comprises:
a second incident surface configured to allow the light exiting from the second incident lens part to enter the second incident surface; and
a second emergent surface configured to allow the light entering the second incident surface to exit,
wherein the second incident surface is curved rearward in a direction from one side end to the other side end along the horizontal direction of the second emergent lens part, and
wherein the second emergent surface has a shape corresponding to the second incident surface along the horizontal direction of the second emergent lens part.

A width of the first incident lens part in the horizontal direction may be smaller than a width of the second incident lens part in the horizontal direction.

A width of the first emergent lens part in the horizontal direction may be smaller than a width of the second emergent lens part in the horizontal direction.

A width of the first incident lens part in the horizontal direction may be larger than a width of the first emergent lens part in the horizontal direction.

A width of the second incident lens part in the horizontal direction may be smaller than a width of the second emergent lens part in the horizontal direction.

The second light source part may be disposed forward of the first light source part.

According to the embodiment of the present disclosure, the first incident lens part and the second incident lens part are integrated, and the first emergent lens part and the second emergent lens part are integrated, thereby simplifying the component structure, minimizing the assembling tolerance, and improving the manufacturability. Further, the central light distribution and the peripheral light distribution may be stably formed, thereby improving luminous efficiency.

### BRIEF DESCRIPTION OF THE DRAWINGS

FIG. 1 is a perspective view illustrating a lamp for a vehicle according to an embodiment of the present disclosure.

FIG. 2 is a top plan view illustrating the lamp for a vehicle according to the embodiment of the present disclosure.

FIG. 3 is a side view illustrating a first incident lens part and a first emergent lens part according to the embodiment of the present disclosure.

FIG. 4 is an enlarged perspective view illustrating a first light source part and a first light entering portion according to the embodiment of the present disclosure.

FIG. 5 is a side view illustrating a second incident lens part and a second emergent lens part according to the embodiment of the present disclosure.

FIG. 6 is an enlarged cross-sectional view illustrating the lamp for a vehicle including a protrusion portion according to another embodiment of FIG. 1.

FIG. 7 is an image illustrating a first light distribution pattern obtained by the lamp for a vehicle according to the embodiment in FIG. 6.

FIG. 8 is an image illustrating a luminous intensity distribution of the first light distribution pattern obtained by the lamp for a vehicle according to the embodiment in FIG. 6.

FIG. 9 is a perspective view illustrating the second incident lens part and the second emergent lens part according to the embodiment of the present disclosure.

FIG. 10 is an image illustrating a second light distribution pattern obtained by the lamp for a vehicle according to the embodiment of the present disclosure.

### DETAILED DESCRIPTION

Hereinafter, the disclosed embodiment will be described in detail with reference to the accompanying drawings.

However, the technical spirit of the disclosed embodiment is not limited to some embodiments described herein but may be implemented in various different forms. One or more of the constituent elements in the embodiments may be selectively combined and substituted for use within the scope of the technical spirit of the disclosed embodiment.

In addition, unless otherwise specifically and explicitly defined and stated, the terms (including technical and scientific terms) used in the disclosed embodiment may be construed as the meaning which may be commonly understood by the person with ordinary skill in the art to which the disclosed embodiment pertains. The meanings of the commonly used terms such as the terms defined in dictionaries may be interpreted in consideration of the contextual meanings of the related technology.

In addition, the terms used in the disclosed embodiment are for explaining the embodiments, not for limiting the disclosed embodiment.

In the disclosed embodiment, unless particularly stated otherwise, a singular form may also include a plural form. The expression “at least one (or one or more) of A, B, and C” may include one or more of all combinations that can be made by combining A, B, and C.

In addition, the terms such as first, second, A, B, (a), and (b) may be used to describe constituent elements of the disclosed embodiment.

These terms are used only for the purpose of discriminating one constituent element from another constituent element, and the nature, the sequences, or the orders of the constituent elements are not limited by the terms.

Further, when one constituent element is described as being ‘connected,’ ‘coupled,’ or ‘attached’ to another constituent element, one constituent element may be connected, coupled, or attached directly to another constituent element or connected, coupled, or attached to another constituent element through still another constituent element interposed therebetween.

In addition, the expression “one constituent element is provided or disposed above (on) or below (under) another constituent element” includes not only a case in which the two constituent elements are in direct contact with each other, but also a case in which one or more other constituent elements are provided or disposed between the two constituent elements. The expression “above (on) or below (under)” may mean a downward direction as well as an upward direction based on one constituent element.

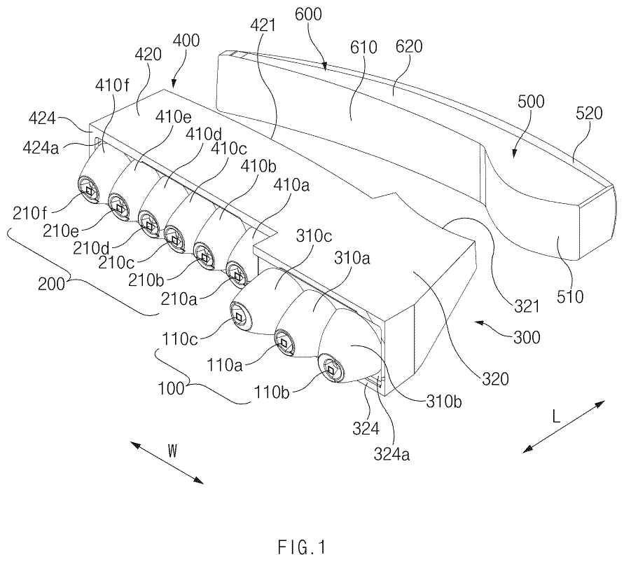

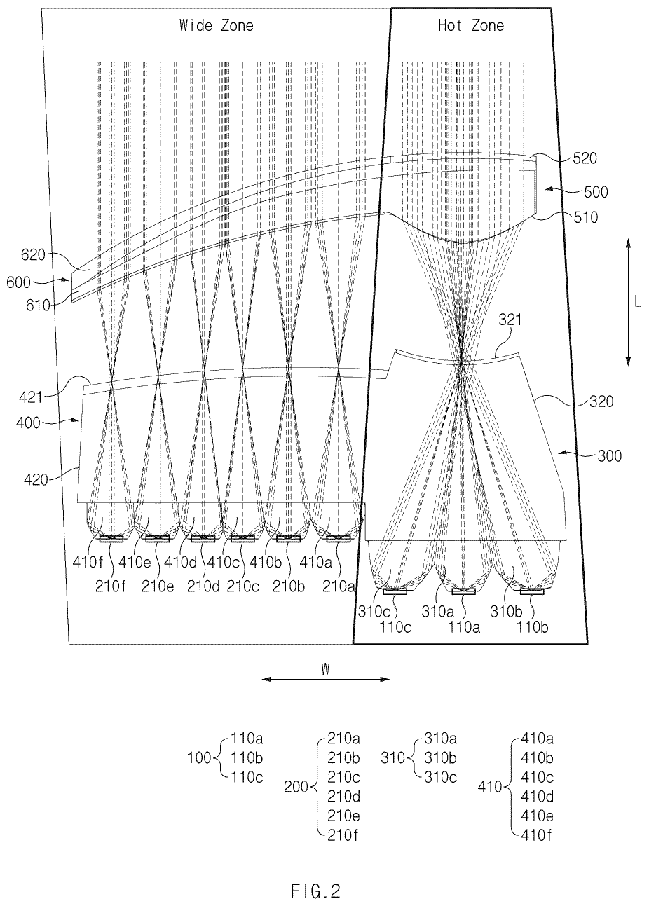

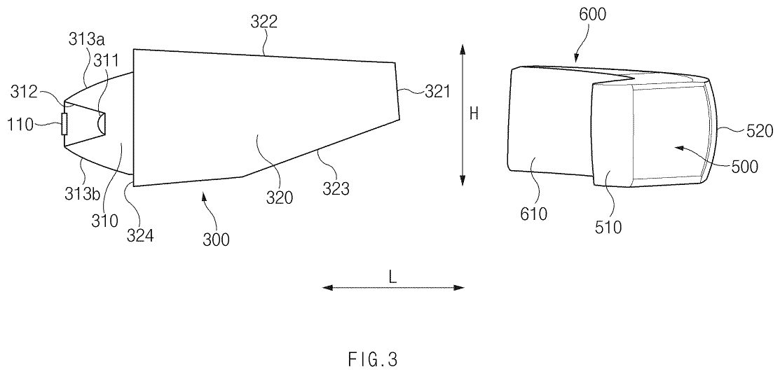

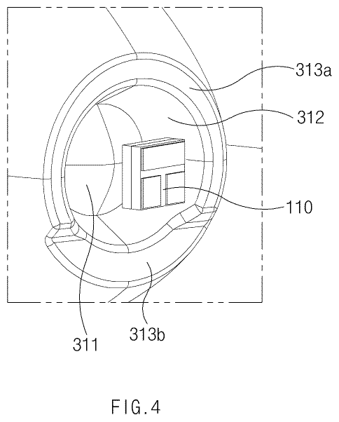

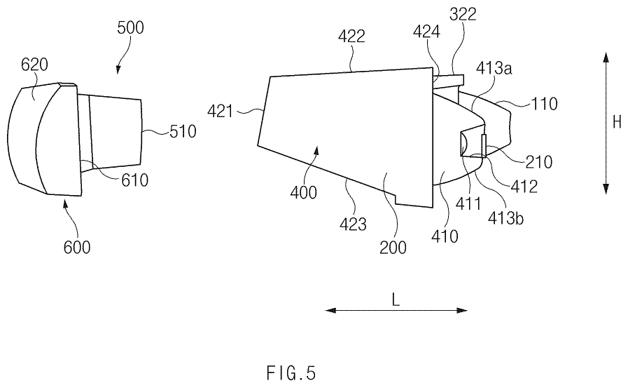

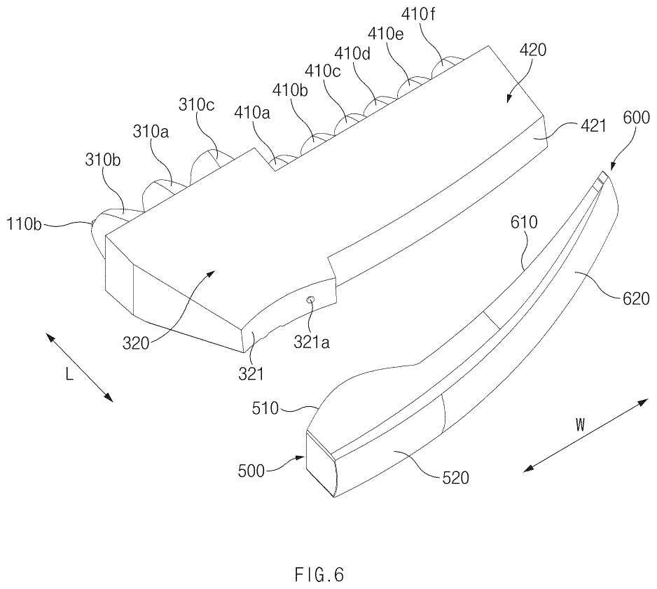

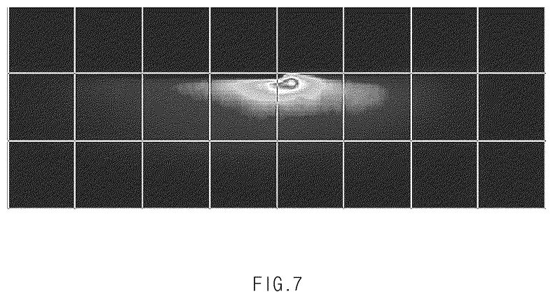

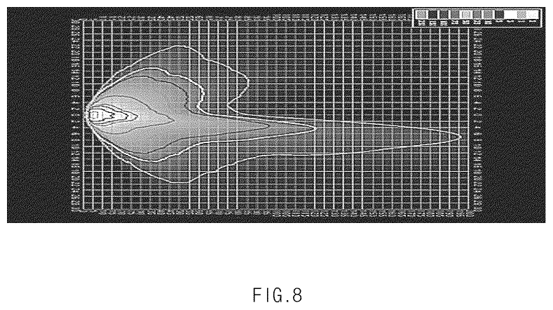

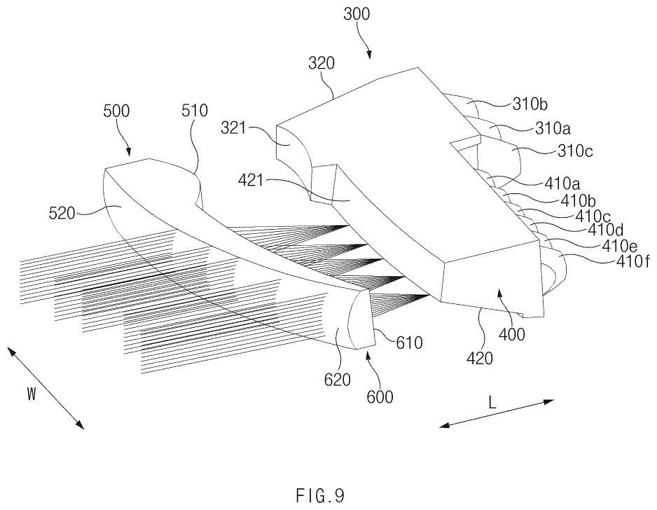

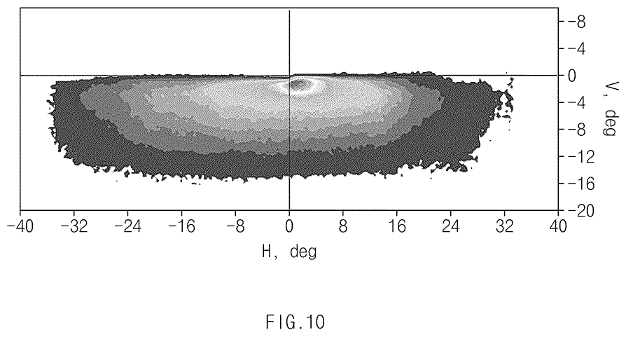

FIG. 1 is a perspective view illustrating a lamp for a vehicle according to an embodiment of the present disclosure. FIG. 2 is a top plan view illustrating the lamp for a vehicle according to the embodiment of the present disclosure. FIG. 3 is a side view illustrating a first incident lens part and a first emergent lens part according to the embodiment of the present disclosure. FIG. 4 is an enlarged perspective view illustrating a first light source part and a first light entering portion according to the embodiment of the present disclosure. FIG. 5 is a side view illustrating a second incident lens part and a second emergent lens part according to the embodiment of the present disclosure. FIG. 6 is an enlarged cross-sectional view illustrating the lamp for a vehicle including a protrusion portion according to another embodiment of FIG. 1. FIG. 7 is an image illustrating a first light distribution pattern obtained by the lamp for a vehicle according to the embodiment in FIG. 6. FIG. 8 is an image illustrating a luminous intensity distribution of the first light distribution pattern obtained by the lamp for a vehicle according to the embodiment in FIG. 6. FIG. 9 is a perspective view illustrating the second incident lens part and the second emergent lens part according to the embodiment of the present disclosure. FIG. 10 is an image illustrating a second light distribution pattern obtained by the lamp for a vehicle according to the embodiment of the present disclosure.

With reference to FIGS. 1 to 10, a lamp 10 for a vehicle according to an embodiment of the present disclosure may include all or some of a first light source part 100, a second light source part 200, a first incident lens part 300, a second incident lens part 400, a first emergent lens part 500, and a second emergent lens part 600.

The first light source part 100 may include one or more first light sources 110a, 110b, and 110c configured to emit light. The first light source part 100 may be disposed at one side based on a horizontal direction W. The plurality of first light sources 110a, 110b, and 110c may be arranged in the horizontal direction W.

The second light source part 200 may include one or more second light sources 210a, 210b, 210c, 210d, 210e, and 210f configured to emit light. The second light source part 200 may be disposed at the other side of the first light source part 100. The second light source part 200 may be disposed to be spaced apart from the first light source part 100 at a predetermined distance or more. Specifically, the second light source part 200 may be disposed forward of the first light source part 100. The plurality of second light sources 210a, 210b, 210c, 210d, 210e, and 210f may be arranged in the horizontal direction W.

An element or device capable of emitting light may be used for the first light source part 100 and the second light source part 200. For example, a diode (light-emitting diode, hereinafter, referred to as an ‘LED’) may be used for the first light source part 100 and the second light source part 200. In addition, the first light source part 100 and the second light source part 200 may be mounted on a substrate part (not illustrated), such as a printed circuit board.

The first incident lens part 300 may be disposed forward of the first light source part 100 and configured to allow the light emitted from the first light source part 100 to propagate forward. The first incident lens part 300 may be disposed at one side based on the horizontal direction W.

The first incident lens part 300 may include all or some of first light entering portions 310a, 310b, and 310c and a first body portion 320.

The first light entering portions 310a, 310b, and 310c may be disposed to face the first light sources 110a, 110b, and 110c and configured such that the light beams emitted from the first light sources 110a, 110b, and 110c enter the first light entering portions 310a, 310b, and 310c and are totally reflected. That is, the first light entering portions 310a, 310b, and 310c may be provided as one or more first light entering portions 310a, 310b, and 310c corresponding in number to the first light sources 110a, 110b, and 110c. The first light entering portions 310a, 310b, and 310c may be formed in shapes protruding rearward from the first body portion 320.

The first body portion 320 may be provided forward of the one or more first light entering portions 310a, 310b, and 310c and integrated with the one or more first light entering portions 310a, 310b, and 310c. The first body portion 320 may be configured to guide the light beams, which enter the first body portion 320 from the one or more first light entering portions 310a, 310b, and 310c, forward.

A light exit surface 321 may be formed at a front side of the first body portion 320. That is, the light exit surface 321 of the first body portion may be configured to allow the light guided from the first body portion 320 to propagate forward. In addition, the light exit surface 321 of the first body portion 320 may be formed in a shape in which a cross-sectional shape in the horizontal direction W of the light exit surface 321 of the first body portion 320 is concavely curved rearward. More specifically, in order to improve visibility of a central light distribution (hot zone), a central region of a cross-section in the horizontal direction W of the light exit surface 321 of the first body portion 320 may be most curved rearward. In this case, the central light distribution refers to a long-distance light distribution pattern for ensuring a visual field of a central region of a front side.

With reference to FIGS. 6 to 8, the light exit surface 321 of the first body portion 320 may further include a protrusion portion 321a protruding forward from one side of the light exit surface 321 of the first body portion 320. For example, the protrusion portion 321a may be formed to be biased toward the second incident lens part 400 with respect to a center of the first body portion 320 based on the horizontal direction W and serve as a light-blocking means for reducing luminance at a specific site. Because this photosensitive region may vary depending on light distribution regulations or design conditions of application areas, the position, shape, and size of the protrusion portion 321a may be variously modified in accordance with the design conditions.

A lower surface 323 of the first body portion may be formed to be inclined upward in a direction toward the light exit surface 321 of the first body portion 320.

Rear surfaces 324 and 324a of the first body portion 320 may include a central region 324a from which the one or more first light entering portions 310a, 310b, and 310c protrude, and an outer peripheral region 324 configured to surround the first light entering portions 310a, 310b, and 310c. The outer peripheral region 324 may protrude rearward further than the central region 324a and define a stepped portion.

A width of the first body portion 320 may decrease in the forward direction. Therefore, a width of the light exit surface 321 of the first body portion 320 may be smaller than a width of each of the rear surfaces 324 and 324a of the first body portion 320. That is, the shape, which is narrowed in the forward direction, may allow the light beams entering through the plurality of first light entering portions 310a, 310b, and 310c to be concentrated on the central region based on the horizontal direction W, such that the central light distribution may be formed on the light exit surface 321 of the first body portion 320.

The first light entering portions 310a, 310b, and 310c may each include all or some of a first central incident portion 311, a first lateral incident portion 312, and a first outer peripheral incident portion 313.

The first central incident portion 311 may be configured to refract a first central light beam, which is a part of the light emitted from the first light sources 110a, 110b, and 110c, so that the first central light beam propagates toward the central region of the light exit surface 321 of the first body portion.

The first lateral incident portion 312 may extend from the first central incident portion 311 to the first outer peripheral incident portion 313.

The first outer peripheral incident portion 313 may be configured to totally reflect a first peripheral light beam, which is another part of the light emitted from the first light sources 110a, 110b, and 110c, so that the first peripheral light beam propagates toward the central region of the light exit surface 321 of the first body portion 320. The first outer peripheral incident portion 313 may be provided to surround the first central incident portion 311.

A distance in a forward/rearward direction L between a lower end 313b of the first outer peripheral incident portion and the first light source part 100 may be longer than a distance in the forward/rearward direction L between an upper end 313a of the first outer peripheral incident portion and the first light source part 100. For example, the lower end 313b of the first outer peripheral incident portion may be farther from the first light source part 100 than the upper end 313a of the first outer peripheral incident portion from the first light source part 100, such that a stepped portion based on the forward/rearward direction L may be formed between the upper end 313a of the first outer peripheral incident portion and the lower end 313b of the first outer peripheral incident portion.

The plurality of first light entering portions 310a, 310b, and 310c may be formed such that optical axes of the plurality of first light entering portions 310a, 310b, and 310c become closer to a central axis based on the horizontal direction W of the light exit surface 321 of the first body portion 320 in the forward direction. For example, the plurality of first light entering portions 310a, 310b, and 310c may be disposed symmetrically with respect to the central axis based on the horizontal direction W of the light exit surface 321 of the first body portion 320, such that the light beams entering through the first light entering portions 310a, 310b, and 310c may propagate toward the central region of the light exit surface 321 of the first body portion 320.

The second incident lens part 400 may be disposed forward of the second light source part 200 and configured to allow the light emitted from the second light source part 200 to propagate forward. The second incident lens part 400 may be disposed at the other side based on the horizontal direction W. The second incident lens part 400 may be disposed at one side of the first incident lens part 300 based on the horizontal direction W and integrated with the first incident lens part 300.

The second incident lens part 400 may include all or some of second light entering portions 410a, 410b, 410c, 410d, 410e, and 410f and a second body portion 420.

The second light entering portions 410a, 410b, 410c, 410d, 410e, and 410f may be disposed to face the second light sources 210a, 210b, 210c, 210d, 210e, and 210f and configured such that the light beams emitted from the second light sources 210a, 210b, 210c, 210d, 210e, and 210f enter the second light entering portions 410a, 410b, 410c, 410d, 410e, and 410f and are totally reflected. That is, the second light entering portions 410a, 410b, 410c, 410d, 410e, and 410f may be provided as one or more second light entering portions 410a, 410b, 410c, 410d, 410e, and 410f corresponding in number to the second light sources 210a, 210b, 210c, 210d, 210e, and 210f. The second light entering portions 410a, 410b, 410c, 410d, 410e, and 410f may be formed in shapes protruding rearward from the second body portion 420.

The second body portion 420 may be provided forward of the one or more second light entering portions 410a, 410b, 410c, 410d, 410e, and 410f and integrated with the one or more second light entering portions 410a, 410b, 410c, 410d, 410e, and 410f. The second body portion 420 may be configured to guide the light beams, which enter the second body portion 420 from the one or more second light entering portions 410a, 410b, 410c, 410d, 410e, and 410f, forward.

A light exit surface 421 may be formed at a front side of the second body portion 420. That is, the light exit surface 421 of the second body portion 420 may be configured to allow the light guided from the second body portion 420 to propagate forward. In addition, the light exit surface 421 of the second body portion 420 may be formed in a shape in which a cross-sectional shape in the horizontal direction W of the light exit surface 421 of the second body portion 420 is convexly curved forward. More specifically, the cross-sectional shape in the horizontal direction W of the light exit surface 421 of the second body portion 420 may be formed to be gently curved so that the light is diffused in a larger range. With the above-mentioned shape, the light beams emitted from the second light sources 210a, 210b, 210c, 210d, 210e, and 210f may propagate at different light distribution angles, thereby forming an entirely uniform peripheral light distribution (wide zone). In this case, the peripheral light distribution refers to a light distribution pattern for ensuring a visual field of a front peripheral region and ensuring visibility when a vehicle turns.

A lower surface 423 of the second body portion may be formed to be inclined upward in a direction toward the light exit surface 421 of the second body portion 420.

Rear surfaces 424 and 424a of the second body portion 420 may include a central region 424a from which the one or more second light entering portions 410a, 410b, 410c, 410d, 410e, and 410f protrude, and an outer peripheral region 424 configured to surround the second light entering portions 410a, 410b, 410c, 410d, 410e, and 410f. The outer peripheral region 424 may protrude rearward further than the central region 424a and define a stepped portion.

A width of the second body portion 420 may increase in the forward direction. Therefore, a width of the light exit surface 421 of the second body portion 420 may be larger than a width of each of the rear surfaces 424 and 424a of the second body portion 420. That is, the shape, which is widened in the forward direction, may allow the light beams entering through the plurality of second light entering portions 410a, 410b, 410c, 410d, 410e, and 410f to exit from different positions on the light exit surface 421 of the second body portion 420, thereby forming different light distribution angles and implementing the peripheral light distribution in a large range. In addition, because the width of the light exit surface is large, optical axes of the second light sources 210a, 210b, 210c, 210d, 210e, and 210f may be maintained without being distorted, and a more uniform light distribution may be achieved, thereby improving overall luminous efficiency.

The second light entering portions 410a, 410b, 410c, 410d, 410e, and 410f may each include all or some of a second central incident portion 411, a second lateral incident portion 412, and a second outer peripheral incident portion 413.

The second central incident portion 411 may be configured to refract a second central light beam, which is a part of the light emitted from the second light sources 210a, 210b, 210c, 210d, 210e, and 210f, so that the second central light beam propagates toward the central region of the light exit surface 421 of the second body portion 420.

The second lateral incident portion 412 may extend from the second central incident portion 411 to the second outer peripheral incident portion 413.

The second outer peripheral incident portion 413 may be configured to totally reflect a second peripheral light beam, which is another part of the light emitted from the second light sources 210a, 210b, 210c, 210d, 210e, and 210f, so that the second peripheral light beam propagates toward the central region of the light exit surface 421 of the second body portion 420. The second outer peripheral incident portion 413 may be provided to surround the second central incident portion 411.

A distance in the forward/rearward direction L between a lower end 413b of the second outer peripheral incident portion and the second light source part 200 may be longer than a distance in the forward/rearward direction L between an upper end 413a of the second outer peripheral incident portion and the second light source part 200. For example, the lower end 413b of the second outer peripheral incident portion may be farther from the second light source part 200 than the upper end 413a of the second outer peripheral incident portion from the second light source part 200, such that a stepped portion based on the forward/rearward direction L may be formed between the upper end 413a of the second outer peripheral incident portion and the lower end 413b of the second outer peripheral incident portion.

The light beams entering through the plurality of second light entering portions 410a, 410b, 410c, 410d, 410e, and 410f may propagate forward along the optical axes of the light entering portions and exit from different positions on the light exit surface 421 of the second body portion 420. That is, because the light exit surface 421 of the second body portion 420 is formed as a curved surface gently curved in the horizontal direction W, the light beams entering the light entering portions may exit in different directions in accordance with the position and the curvature of the light exit surface 421 of the second body portion 420. Therefore, the light may be dispersed over the entire light exit surface 421 of the second body portion 420, such that the peripheral light distribution may be formed.

A width of the first incident lens part 300 in the horizontal direction W may be smaller than a width of the second incident lens part 400 in the horizontal direction W.

An upper surface 322 of the first body portion and an upper surface 422 of the second body portion may be integrated.

The light exit surface 321 of the first body portion 320 may be positioned forward of the light exit surface 421 of the second body portion 420, and the rear surfaces 324 and 324a of the first body portion 320 may be positioned rearward of the rear surfaces 424 and 424a of the second body portion 420. Therefore, a stepped portion based on the forward/rearward direction L may be formed between the first incident lens part 300 and the second incident lens part 400.

The first emergent lens part 500 may be disposed forward of the first incident lens part 300 and configured to allow the light exiting from the first incident lens part 300 to enter the first emergent lens part 500. The light, which passes through the first incident lens part 300 and the first emergent lens part 500 from the first light source part 100, may form the central light distribution.

The first emergent lens part 500 may include one or both of a first incident surface 510 and a first emergent surface 520.

The first incident surface 510 may be configured to allow the light exiting from the first incident lens part 300 to enter the first incident surface 510. A cross-sectional shape in the horizontal direction W of the first incident surface 510 may be formed in a shape convexly curved rearward.

The first emergent surface 520 may be configured to allow the light entering the first incident surface 510 to propagate forward. A cross-sectional shape in the horizontal direction W of the first emergent surface 520 may be formed in a shape convexly curved forward. For example, the first incident surface 510 and the first emergent surface 520 may be formed symmetrically in the horizontal direction W with respect to the optical axis of the first emergent lens part 500.

The second emergent lens part 600 may be disposed forward of the second incident lens part 400 and configured to allow the light exiting from the second incident lens part 400 to enter the second emergent lens part 600. The second emergent lens part 600 may be disposed at one side of the first emergent lens part 500 based on the horizontal direction W and integrated with the first emergent lens part 500.

The light, which passes through the second incident lens part 400 and the second emergent lens part 600 from the second light source part 200, may form the peripheral light distribution that surrounds the central light distribution. The central light distribution and the peripheral light distribution may overlap each other to form a low-beam light distribution pattern.

The second emergent lens part 600 may include one or both of a second incident surface 610 and a second emergent surface 620.

The second incident surface 610 may be configured to allow the light exiting from the second incident lens part 400 to enter the second incident surface 610. The second incident surface 610 may be formed to be curved rearward in a direction from one side end to the other side end based on the horizontal direction W of the second emergent lens part 600.

The second emergent surface 620 may be configured to allow the light entering the second incident surface 610 to exit. The second emergent surface 620 may be provided to have a shape corresponding to the second incident surface 610 based on the horizontal direction W of the second emergent lens part 600.

More specifically, the first emergent surface 520 and the second emergent surface 620 may be formed in different shapes, but the first emergent surface 520 and the second emergent surface 620 may be continuously formed without a portion stepped in the horizontal direction W. The first emergent surface 520 and the second emergent surface 620, which are disposed at the front side and define an external appearance of the lamp 10 for a vehicle, are formed continuously, such that the lamp 10 for a vehicle according to the present disclosure may provide an advantageous design effect by minimizing interruption between the light distribution patterns having different characteristics.

A width of the first emergent lens part 500 in the horizontal direction W may be smaller than a width of the second emergent lens part 600 in the horizontal direction W. Specifically, the first emergent lens part 500 may be formed to have a comparatively small width in the horizontal direction W so that the concentrated light is aligned in a predetermined direction and exits. On the contrary, because the second emergent lens part 600 is structured to disperse the light beams, which are transmitted from the plurality of second light entering portions 410a, 410b, 410c, 410d, 410e, and 410f, in a large range and output the light beams, the second emergent lens part 600 may be configured to have a larger width in the horizontal direction W.

The first incident surface 510 may be positioned forward of the second incident surface 610, and the first emergent surface 520 may be positioned forward of the second emergent surface 620.

A width of the first incident lens part 300 in the horizontal direction W may be larger than a width of the first emergent lens part 500 in the horizontal direction W. Specifically, the first incident lens part 300 may include the plurality of first light entering portions 310a, 310b, and 310c while corresponding to the first light source part 100, and the plurality of first light entering portions 310a, 310b, and 310c may be dispersed and disposed in the horizontal direction W. Therefore, the first incident lens part 300 may be formed to have a comparatively large width. On the contrary, because the first emergent lens part 500 is configured such that the light introduced through the first incident lens part 300 is collected toward the central region of the first emergent lens part 500 based on the horizontal direction W, the first emergent lens part 500 may have a smaller width in the horizontal direction W as a whole.

A width of the second incident lens part 400 in the horizontal direction W may be smaller than a width of the second emergent lens part 600 in the horizontal direction W. Specifically, the second emergent lens part 600 may be formed to be larger in width in the horizontal direction W than the second incident lens part 400 in order to form the peripheral light distribution by widely diffusing the light, which is introduced through the second incident lens part 400, in the horizontal direction W.

A width of each of the first incident surface 510 and the first emergent surface 520 in the forward/rearward direction L may be larger than a width of each of the second incident surface 610 and the second emergent surface 620 in the forward/rearward direction L. Specifically, the widths of the first incident surface 510 and the first emergent surface 520 in the forward/rearward direction L are required to ensure sufficient optical paths in the optical axis direction in order to form the central light distribution. Therefore, the first incident surface 510 and the first emergent surface 520 may be formed to have a relatively large width in the forward/rearward direction L. On the contrary, the widths of the second incident surface 610 and the second emergent surface 620 in the forward/rearward direction L are focused on the light diffusion for forming the peripheral light distribution and provide relatively short optical paths. Therefore, the second incident surface 610 and the second emergent surface 620 may be formed to have a small width in the forward/rearward direction L.

The present disclosure has been described with reference to the limited embodiments and the drawings, but the present disclosure is not limited thereby. The present disclosure may be carried out in various forms by those skilled in the art, to which the present disclosure pertains, within the technical spirit of the present disclosure and the scope equivalent to the appended claims.

What is claimed is:

1. A lamp for a vehicle, the lamp comprising:
a first light source part comprising one or more first light sources configured to emit light;
a second light source part comprising one or more second light sources configured to emit light, the second light source part being spaced apart from the first light source part by at least a predetermined distance;
a first incident lens part disposed forward of the first light source part and configured to allow the light emitted from the first light source part to propagate forward;
a second incident lens part disposed forward of the second light source part and configured to allow the light emitted from the second light source part to propagate forward;
a first emergent lens part disposed forward of the first incident lens part to receive the light exiting from the first incident lens part; and
a second emergent lens part disposed forward of the second incident lens part to receive the light exiting from the second incident lens part,
wherein the second incident lens part is integrated with the first incident lens part at one side of the first incident lens part in a horizontal direction,
wherein the second emergent lens part is integrated with the first emergent lens part at one side of the first emergent lens part in the horizontal direction,
wherein the first light source part, the first incident lens part, and the first emergent lens part are configured to form a central light distribution, and the second light source part, the second incident lens part, and the second emergent lens part are configured to form a peripheral light distribution surrounding the central light distribution to collectively form a low-beam light distribution pattern.

2. The lamp of claim 1, wherein the first incident lens part comprises:
one or more first light entering portions facing the first light source and configured to totally reflect the light emitted from the first light source; and
a first body portion provided forward of and integrated with the first light entering portion, the first body portion including a light exit surface configured to allow the light guided through the first body portion to propagate forward,
wherein the first light entering portion is formed in a shape protruding rearward from the first body portion.

3. The lamp of claim 2, wherein the first light entering portion comprises:
a first central incident portion configured to refract a first central light beam, which is a part of the light emitted from the first light source, toward a central region of the light exit surface of the first body portion; and
a first outer peripheral incident portion surrounding the first central incident portion and configured to totally reflect a first peripheral light beam, which is another part of the light emitted from the first light source, toward the central region of the light exit surface of the first body portion, and
wherein a distance in a forward/rearward direction between a lower end of the first outer peripheral incident portion and the first light source part is longer than a distance in the forward/rearward direction between an upper end of the first outer peripheral incident portion and the first light source part.

4. The lamp of claim 2, wherein the light exit surface of the first body portion is concavely curved rearward in a cross-sectional view along the horizontal direction.

5. The lamp of claim 2, wherein the light exit surface of the first body portion further comprises a protrusion portion protruding forward from one side of the light exit surface of the first body portion.

6. The lamp of claim 2, wherein the protrusion portion is biased toward the second incident lens part with respect to a center of the first body portion in the horizontal direction.

7. The lamp of claim 2, wherein a plurality of first light entering portions are formed such that optical axes of the plurality of first light entering portions converge toward a central axis of the light exit surface of the first body portion in a forward direction.

8. The lamp of claim 2, wherein a lower surface of the first body portion is inclined upward in a direction toward the first light exit surface.

9. The lamp of claim 1, wherein the second incident lens part comprises:
one or more second light entering portions facing the second light source and configured to totally reflect the light emitted from the second light source; and
a second body portion provided forward of and integrated with the second light entering portion, the second body portion including a light exit surface configured to allow the light guided through the second body portion to propagate forward,
wherein the second light entering portion is formed in a shape protruding rearward from the second body portion.

10. The lamp of claim 9, wherein the second light entering portion comprises:
a second central incident portion configured to refract a second central light beam, which is a part of the light emitted from the second light source, toward a central region of the light exit surface of the second body portion; and
a second outer peripheral incident portion surrounding the second central incident portion and configured to totally reflect a second peripheral light beam, which is another part of the light emitted from the second light source, toward the central region of the light exit surface of the second body portion, and
wherein a distance in a forward/rearward direction between a lower end of the second outer peripheral incident portion and the second light source part is longer than a distance in the forward/rearward direction between an upper end of the second outer peripheral incident portion and the second light source part.

11. The lamp of claim 9, wherein the light exit surface of the second body portion is convexly curved forward in a cross-sectional view along the horizontal direction.

12. The lamp of claim 9, wherein a lower surface of the second body portion is inclined upward in a direction toward the second light exit surface.

13. The lamp of claim 1, wherein the first emergent lens part comprises:
a first incident surface configured to allow the light exiting from the first incident lens part to enter the first incident surface; and
a first emergent surface configured to allow the light entering the first incident surface to propagate forward,
wherein the first incident surface is convexly curved rearward in a cross-sectional view along the horizontal direction, and
wherein the first emergent surface is convexly curved forward in a cross-sectional view along the horizontal direction.

14. The lamp of claim 1, wherein the second emergent lens part comprises:
a second incident surface configured to allow the light exiting from the second incident lens part to enter the second incident surface; and
a second emergent surface configured to allow the light entering the second incident surface to exit,
wherein the second incident surface is curved rearward in a direction from one side end to the other side end along the horizontal direction of the second emergent lens part, and
wherein the second emergent surface has a shape corresponding to the second incident surface along the horizontal direction of the second emergent lens part.

15. The lamp of claim 1, wherein a width of the first incident lens part in the horizontal direction is smaller than a width of the second incident lens part in the horizontal direction.

16. The lamp of claim 1, wherein a width of the first emergent lens part in the horizontal direction is smaller than a width of the second emergent lens part in the horizontal direction.

17. The lamp of claim 1, wherein a width of the first incident lens part in the horizontal direction is larger than a width of the first emergent lens part in the horizontal direction.

18. The lamp of claim 1, wherein a width of the second incident lens part in the horizontal direction is smaller than a width of the second emergent lens part in the horizontal direction.

19. The lamp of claim 1, wherein the second light source part is disposed forward of the first light source part.
